(19) United States
(12) Patent Application Publication
(10) Pub. No.: US 2014/0154989 A1
(43) Pub. Date: Jun. 5, 2014

(54) WIRELESS HANDS FREE DEVICE FOR EQUESTRIAN RIDING ACTIVITIES

(71) Applicant: Leah Colleen Lane, Carlsbad, CA (US)

(72) Inventor: Leah Colleen Lane, Carlsbad, CA (US)

(21) Appl. No.: 14/097,208

(22) Filed: Dec. 4, 2013

Related U.S. Application Data
(60) Provisional application No. 61/733,328, filed on Dec. 4, 2012.

(51) Int. Cl. H04R 3/12; B68B 5/06; H04R 1/02; H04B 7/24

(52) U.S. Cl. CPC H04R 3/12; H04B 7/24; B68B 5/06; H04R 1/02
USPC 455/41.2; 381/77

(57) ABSTRACT

A hands free device adapted to be used during equestrian riding activity is described. The hands free device includes: an enclosure that houses a set of speakers, a microphone, and a wireless communication module; and a securing feature that is adapted to be coupled to the enclosure and secured to an attachment point. A portable speaker adapted to be used during horseback riding includes: a crescent-shaped enclosure that includes: a set of speakers; and a recessed area running along an outer surface of the enclosure; and a securing strap that includes: a retaining loop adapted to form a compression fit about the enclosure at the recessed area; and an adjustable securing feature that includes a retaining element and a set of receptacles, each receptacle adapted to be able to be coupled to the retaining element. A media playback device adapted for use during horseback riding is described.

### CROSS-REFERENCE TO RELATED APPLICATIONS

This application claims priority to U.S. Provisional Patent Application Ser. No. 61/733,328, filed on Dec. 4, 2012.

### BACKGROUND OF THE INVENTION

Mobile devices such as smartphones, mp3 players, etc. are ubiquitous in society. Such devices may be used to play multimedia content (e.g., audio, video, etc.).

Many users of such mobile devices may wish to play content during a variety of activities (e.g., equestrian activities, cycling, etc.) and/or to operate the mobile device in a “hands free” way such that the user is not required to directly access the mobile device and/or to release hold of a control element (e.g., reigns, handlebars, etc.).

Existing solutions such as headphones may pose a safety risk, as a rider may not be able to hear other riders, vehicles, etc. Existing solutions that do not block a rider's hearing (e.g., external speakers) may not be able to be securely fastened during a riding activity (and/or other appropriate activity). Furthermore, wired solutions may pose a safety risk as cables may become tangled, interfere with a rider's (and/or animal's) movements, etc.

Therefore there exists a need for a multimedia input/output device that is able to be attached during riding activities while allowing safe hands free operation.

### BRIEF SUMMARY OF THE INVENTION

Some embodiments may provide a wireless, rechargeable electronic device within a specifically designed enclosure that is able to be attached to a saddle (and/or other appropriate apparatus) for purposes of communications, audio transfer, and/or utilization of applications able to be executed by an appropriately paired mobile device. The enclosure may be made from plastic and/or other appropriate materials.

Such a device may be used while riding an animal, most commonly during equestrian activity, and/or during other appropriate activities (e.g., non-equine riding styles such as mule riding, use with pack animals such as burros in a non-riding situation, etc.). Such a device may be adapted to be easily controlled, utilized and heard by an equestrian or those participating in animal riding activities in order to safely and effectively send and receive communications, listen to audio, receive information and utilize paired electronics application audio for all intended purposes.

The device may be able to be attached directly to a riding apparatus (e.g., a saddle, handle, etc.), indirectly to some riding equipment (e.g., a saddle bag that is, in turn, attached to a saddle), and/or via another appropriate attachment point (e.g., to an animal's neck). Some embodiments may include an adjustable attachment feature that is able to stretch and/or otherwise adjust to fit various specific attachment points (e.g., a silicon band). In addition, the attachment feature may include an adjustable securing feature that allows a user to select among a range of positions for attachment to various differently sized and/or shaped attachment points (e.g., differently sized saddle horns).

The device may include various components such as, for instance, user interface (UI) elements including buttons and light emitting diode (LED) indicators or displays, a set of powered speakers, a microphone, a wireless communication interface (e.g., Bluetooth), and/or various connection ports.

A first exemplary embodiment of the invention provides a hands free device adapted to be used during equestrian riding activity. The hands free device comprising: an enclosure that houses a set of speakers, a microphone, and a wireless communication module; and a securing feature that is adapted to be coupled to the enclosure and secured to an attachment point.

A second exemplary embodiment of the invention provides a portable speaker adapted to be used during horseback riding. The portable speaker includes: a crescent-shaped enclosure that includes: a set of speakers; and a recessed area running along an outer surface of the enclosure; and a securing strap that includes: a retaining loop adapted to form a compression fit about the enclosure at the recessed area; and an adjustable securing feature that includes a retaining element and a set of receptacles, each receptacle adapted to be able to be coupled to the retaining element.

A third exemplary embodiment of the invention provides a media playback device adapted for use during horseback riding. The device includes: a microphone adapted to receive audio data and send the received audio data to a paired mobile device; a wireless communication module that is adapted to allow the media playback device to receive audio content from the paired mobile device; an amplifier adapted to convert the received audio content into a set of outputs capable of driving a set of speakers; a rechargeable battery and associated charging module; and a removable strap adapted to secure the media playback device to an attachment point.

The preceding Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are set forth in the following drawings.

FIGS. 1A-1C illustrate several views of a hands free device according to an exemplary embodiment of the invention;

FIGS. 2A-2D illustrate several views of an attachment feature used with some embodiments of the hands free device of FIGS. 1A-1C;

FIGS. 3A-3B illustrate several views of an alternatively attachment feature of a hands free device according to an exemplary embodiment of the invention;

FIG. 4 illustrates a schematic block diagram of a conceptual system of some embodiments;

FIG. 5 illustrates a flow chart of a conceptual process used by some embodiments to control mobile device operation;

FIG. 6 illustrates a flow chart of a conceptual process used by some embodiments to allow hands free operation of a mobile device during communication; and

FIG. 7 conceptually illustrates a schematic block diagram of a computer system with which some embodiments of the invention may be implemented.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features.

Broadly, some embodiments of the present invention generally provide a hands free device optimized for use during equestrian activities. Such a hands free device may allow a user to safely and effectively operate and utilize the features of a mobile device (e.g., a smartphone, mp3 player, tablet device, etc.). Such mobile device features may include, for instance, communications, audio, and applications while participating in any animal riding activity (and/or other appropriate activity). In addition, a user may be able to keep a mobile device in a secure position on or near the person performing the activity. The hands free device may be housed in a plastic (or other appropriate material) enclosure that is able to be attached to any saddle (usually on a live animal) which may allow wireless interaction with a mobile device.

Some embodiments may allow communication among riders and/or trainers/handlers while riders perform in an equestrian event.

Several more detailed embodiments of the invention are described in the sections below. Section I provides a conceptual description of an exemplary enclosure of some embodiments. Section II then describes a hardware architecture used by some embodiments. Next, Section III describes various methods of operation used by some embodiments. Lastly, Section IV describes a computer system which implements some of the embodiments of the invention.

### I. Exemplary Implementations

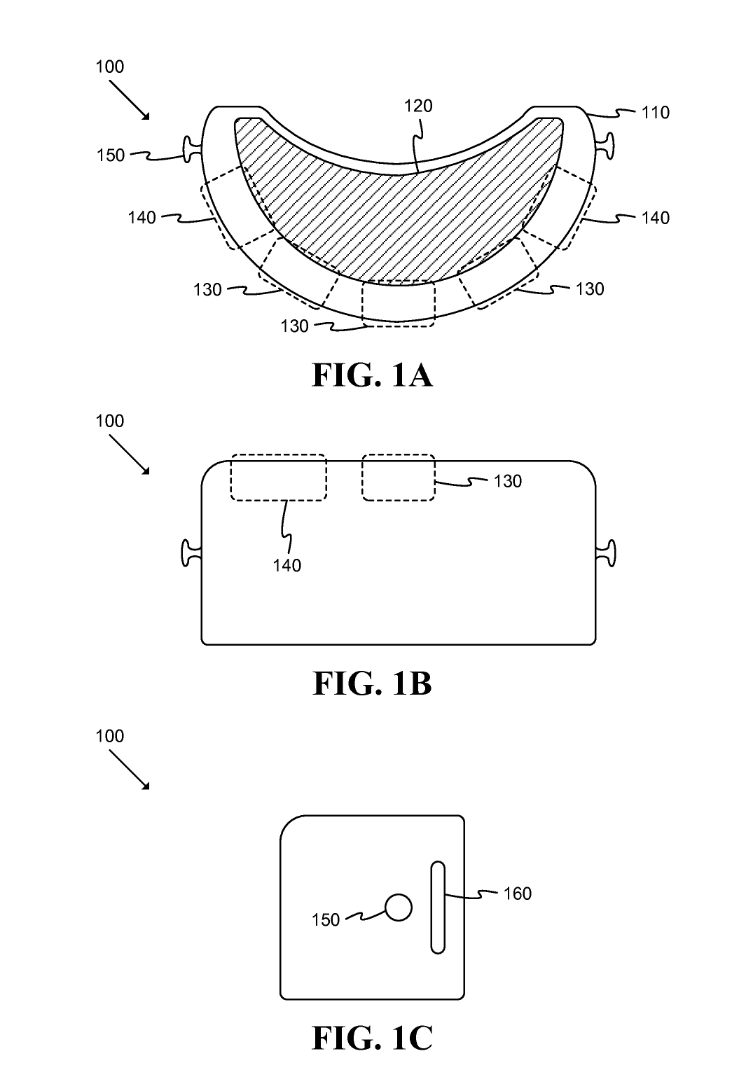

FIG. 1A illustrates a top view of an exemplary hands free device 100 according to some embodiments of the invention. FIG. 1B illustrates a front view of the exemplary hands free device 100. FIG. 1C illustrates a side view of the exemplary hands free device 100. Specifically, these figures show the external features of the hands free device 100.

As shown, the device 100 may include an enclosure 110, a speaker outlet 120, various user interface (UI) elements 130, a set of physical ports 140, a set of fastener connection elements 150, and a fastener receptacle 160. In addition, the device 100 may include various other connections, components, and/or other appropriate elements (not shown).

The enclosure 110 may be shaped such that the enclosure is able to be securely attached to a saddle (or other appropriate apparatus). In some embodiments, the enclosure may have a crescent-like shape that enables the enclosure to be attached or secured to various sections of a typical saddle (e.g., a “horn”, pommel, seat, etc.). Alternatively, the shape may allow the enclosure to be attached to various other appropriate elements (e.g., a bicycle stem, handlebars of a motorized vehicle, etc.).

The enclosure body may be made from various appropriate materials (e.g., plastic, metal, etc.). In some embodiments, the enclosure (or portions thereof) may be covered by various appropriate materials (e.g., rubberized paint, silicon, etc.). The enclosure may be resistant to environmental conditions such as dust, water, etc. (e.g., Ingress Protection Rating or International Protection Rating of IP53). In some embodiments, the enclosure may measure approximately one-and-a-half inches tall, one inch thick, and two-and-a-half inches wide.

The speaker outlet 120 may be a port (or set of ports) in the enclosure body that may be covered by an appropriate protective element (e.g., a sound-permeable element such as a metal grill or mesh). Different embodiments may include different numbers of speaker outlets that may be shaped in various appropriate ways. In this example, the outlet is placed along a top surface of the hands free device, however different embodiments may include one or more outlets placed at different locations along the exterior surface of the enclosure body (e.g., the front, sides, top, etc.). Different embodiments may include different numbers of ports. In some embodiments, in addition to the speaker outlet, the protective element may cover a microphone that is adapted to capture voice output of a user, to facilitate phone calls, voice commands, etc.

The UI elements 130 may include various combinations of input and/or output elements. For example, the UI elements may include various buttons (e.g., power, Bluetooth pairing, play, pause, voice recognition, answer phone, volume up, volume down, mute, next, previous, etc.). Such elements may include various labels (e.g., “+”, “−”, “∘”, etc.) that may be implemented with raised elements in the exterior coating of the enclosure body, and/or otherwise appropriately labeled. The UI elements may be sized and shaped such that a user is able to easily select among the elements when, for instance, wearing riding gloves, during a ride, etc. In addition, as shown in FIG. 1C, the UI elements 130 may be placed along a beveled edge such that buttons, for instance, may be pressed from a variety of angles.

In some embodiments, the UI elements may be multi-function (e.g., the volume up button may be pressed and held to raise volume or quickly pressed and released to advance to the next track). As another example, the UI elements may include various display elements (e.g., LED output(s), display screens, etc.). Such display elements may provide multiple indications (e.g., a tri-color LED that indicates various conditions such as red for mute activated, blue for Bluetooth pairing mode, green for unit on, etc.). In addition, some embodiments may provide audio indicators (e.g., “Bluetooth paired”, “ready to ride”, various tones, etc.).

Each of the physical ports 140 may include a recessed cavity, a removable cover, and/or various connection elements. For instance, one physical port may be associated with a universal serial bus (USB) connection jack while another physical port may be associated with a headphone and/or lineout jack. The removable cover may be made from silicon, rubber, or some other appropriately pliable combination of materials that may allow the cover to form a seal with the recessed cavity when in a closed position but allow access to the cavity when in an open position. Such a cover may include an appropriate tether such that the cover remains attached to the enclosure even in the open position.

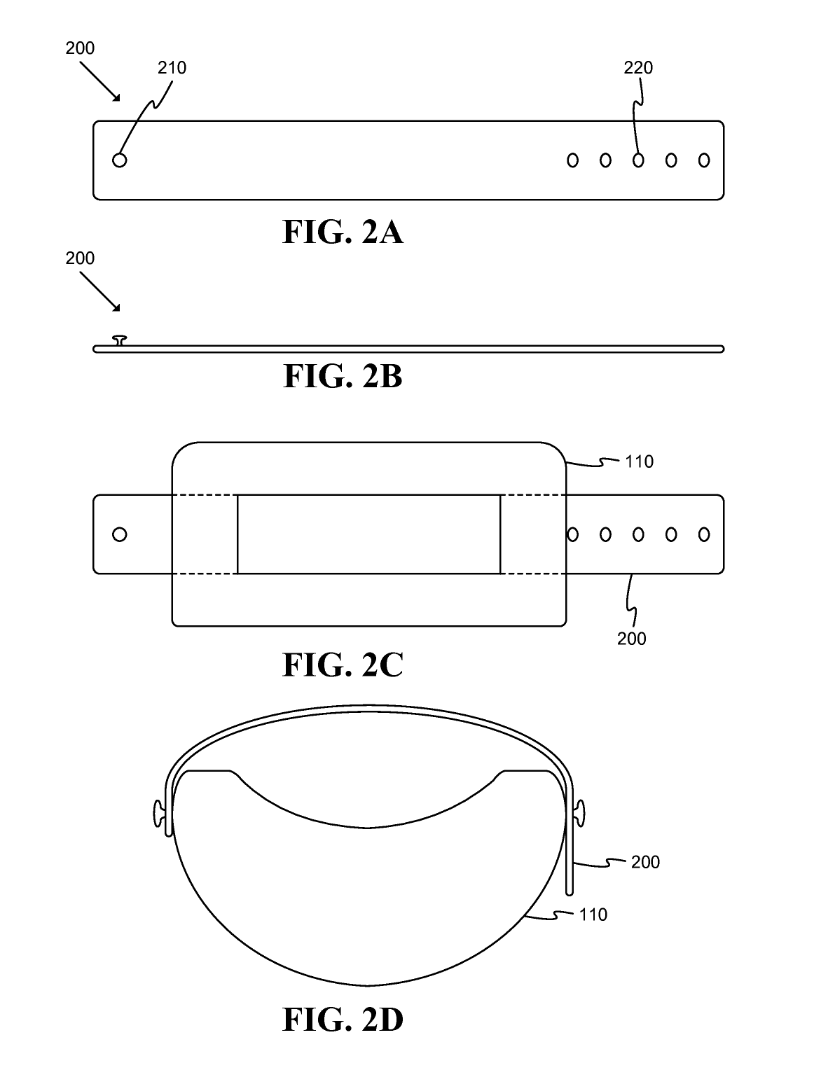

Each fastener connection element 150 may be a raised “nail head” as shown, or other appropriate element (e.g., a snap, button, slot, etc.). Such connection elements may be made from an appropriately rigid material (e.g., plastic, silicon, etc.) such that a fastener may be coupled to the connection element 150. Different embodiments may include different numbers of fastener connection elements (e.g., one, two, etc.) arranged in various different ways. The fastener connection elements may allow a fastener to be secured to the enclosure body such that the hands free device 100 may be secured to an external element (e.g., a portion of a saddle) during use. Various attachment features (or fasteners) will be described in more detail in reference to FIGS. 2A-2D below.

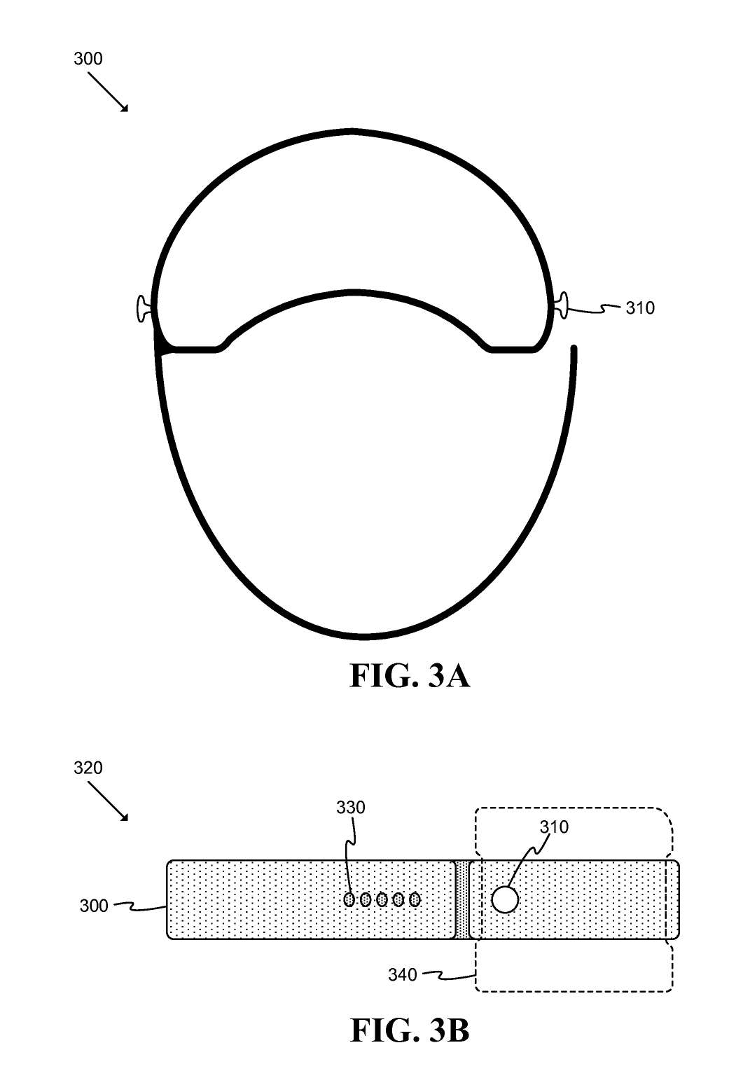

In some embodiments, the fastener connection element 150 may be included with the attachment feature and the enclosure 110 may have a substantially smooth outer surface. One such embodiment will be described in reference to FIGS. 3A-3B.

The fastener receptacle 160 may be a slot or other appropriate element that is able to allow a fastener to pass through at least a portion of the enclosure 110. Some embodiments may include multiple fastener receptacles 160. Each fastener receptacle may be situated such that the receptacle forms a channel from the exterior of the enclosure 110 to the interior cavity defined by the crescent-like shape of the enclosure. Some embodiments may not include any fastener receptacles 160 but may include a recess or other appropriate feature (one such example is described in reference to FIGS. 3A-3B below).

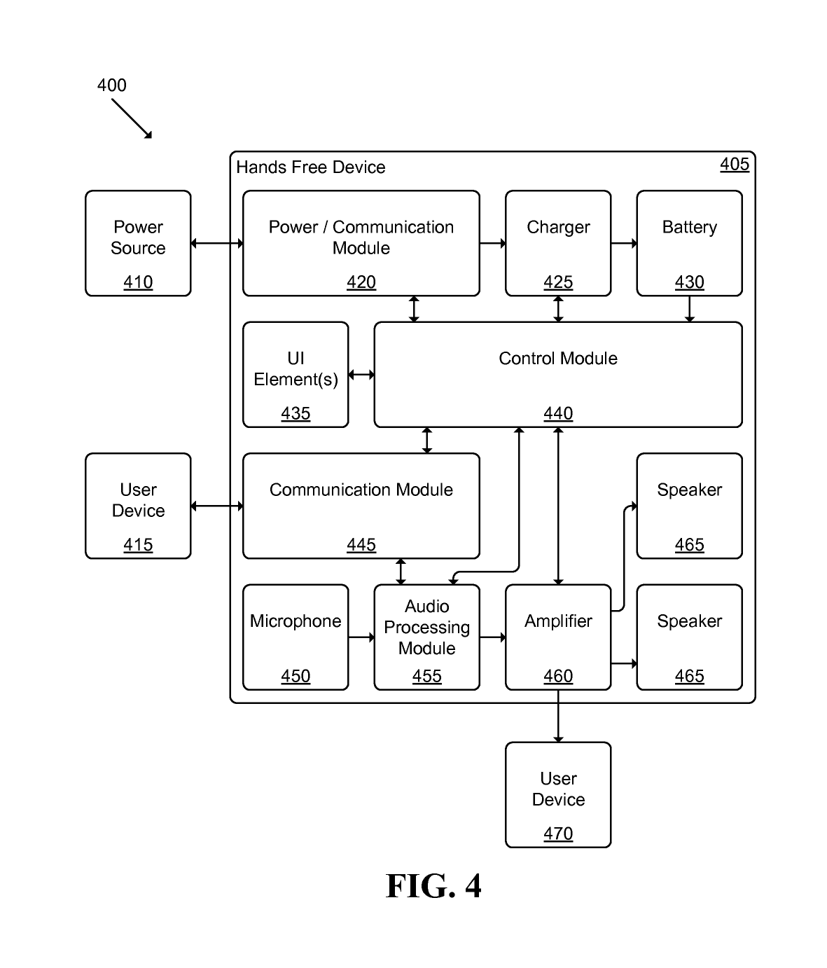

The device 100 may include various other appropriate elements (not shown). For example, some embodiments may include one or more connection ports (e.g., a micro USB port, a line out jack, a line in jack, etc.). In addition, different embodiments may include various different charging sources (e.g., solar cells, hand crank generators, etc.). Some such elements will be described in more detail in reference to FIG. 4 below.

FIG. 2A illustrates a top view of an attachment feature 200 used with some embodiments of the hands free device 100. FIG. 2B illustrates a side view of the attachment feature 200. FIG. 2C illustrates a rear view of the attachment feature 200 as connected to the hands free device 100 in a first configuration. FIG. 2D illustrates a top view of the attachment feature 200 as connected to the hands free device 100 in a second configuration. Specifically, these figures show an exemplary fastener that may be used to secure the hands free device 100 to an external element such as a saddle horn.

As shown, the attachment feature 200 includes a securing element 210 and a set of securing receptacles 220. The securing element 210 may be a “nail head” similar to connection element 150. Alternatively, the securing element 210 may be a through-hole in the attachment feature 200. Each securing receptacle 220 may be a through-hole in the attachment feature 200. In some embodiments, the adjustable attachment feature 200 may measure approximately one inch wide, ten inches long, and two mm thick.

In some embodiments, as shown in FIG. 2C, the securing element 210 may couple to one of the securing receptacles 220 such that the attachment feature 200 may be passed through one or more receptacles 160 and secured to itself. Alternatively, as shown in FIG. 2D, the securing element 210 may be a through-hole that may be attached to the connection element 150, while one of the securing receptacles 220 may be coupled to the same connection element 150 as the securing element 210 or to a different connection element 150 (if available).

In the configuration shown in FIG. 2C, a user may pass the attachment feature 200 through the receptacles 160 and then secure one of the receptacles 220 to the securing element 210 by stretching the receptacle 220 to fit over the securing element 210.

In the configuration shown in FIG. 2D, a user may couple the securing element 210 to a first connection element 150 and then couple one of the securing receptacles to a second connection element 150 (or the first connection element) by stretching the receptacle to fit over the connection element 150.

The attachment feature 200 may be made from an appropriately pliable material (e.g., silicon, rubber, etc.) that is able to be stretched and/or otherwise manipulated such that the enclosure 110 may be secured to an appropriate element. Securing element 210 may be made from a similar material that has sufficient rigidity to be able to form a secure bond with at least one receptacle 220. Multiple spaced receptacles 220 may allow a user to conveniently adjust the attachment feature 200 to be secured to variously sized and/or shaped elements (e.g., horns of different diameter, shape, etc.).

FIG. 3A illustrates a top view of an alternative attachment feature 300 of a hands free device according to an exemplary embodiment of the invention. FIG. 3B illustrates a right side view of a hands free system 320 implemented using the alternative attachment feature. Specifically, these figures show a fitted attachment feature that is molded to fit the speaker enclosure of some embodiments. The fitted attachment feature may be made from various appropriate materials (e.g., silicon, rubber, etc.) and may be sized appropriately to provide a secure fit (e.g., an approximately one-inch wide strap that is one-eighth of an inch thick may be used in some embodiments).

As shown, the attachment feature may include a set of connection elements 310 (e.g., “nail heads” as shown). In such embodiments, the nail heads (or other attachment elements) may not be included with the enclosure. Such connection elements may be secure to one of a set of receptacles 330, where each receptacle may be a through-hole. The attachment feature 300 may form a retaining element (or “loop”) that is able to be secured about an exterior surface of the speaker enclosure 340 of some embodiments. In some cases, as shown, the speaker enclosure may include a recessed area that runs along the exterior surface and corresponds to the loop when the enclosure is mounted within the loop. In addition to the loop, the attachment feature may include a strap that extends from the loop, where the strap includes the set of receptacles 320 such that the end of the strap may be selectively coupled to at least one of the connection elements 310 in order to secure the strap (and thus the loop and speaker enclosure) to an appropriate mounting place during a riding activity.

One of ordinary skill in the art will recognize that the exemplary implementation described above in reference to FIGS. 1A-3B may be implemented in various different ways without departing from the spirit of the invention. In addition, one of ordinary skill in the art will recognize that the exemplary implementation is presented in a conceptual form and the drawings may not necessarily show all components, describe the size and/or scale of the components, and/or otherwise limit various specific implementations of different embodiments of the device. Furthermore, different embodiments may include different specific components, different arrangements of components, differently sized and/or shaped components, and/or otherwise differ from the examples described above.

### II. Hardware Architecture

FIG. 4 illustrates a schematic block diagram of a conceptual system 400 of some embodiments. Specifically, this figure shows various internal elements of a hands free device 405 provided by some embodiments.

As shown, the system 400 may include a hands free device 405, a power source 410, and a user device 415. The power source 410 may be any appropriate power source (e.g., an AC connection, an electronic device, an external battery, etc.) that is able to provide power to device 405. The user device 415 may be any device capable of being communicatively coupled to the device 405. For instance, the user device 415 may be a smartphone, mp3 player, tablet device, PC, laptop, etc.

The hands free device 405 may include a power/communication module 420, a charger 425, a battery 430, a set of UI elements 435, a control module 440, a communication module 445, a microphone 450, an audio processing module 455, an amplifier 460, and a set of speakers 465.

The power/communication module 420 may include an appropriate wired input (e.g., a micro USB connection) that is able to be connected to various types of external devices or power sources. The charger 425 may be adapted to receive power from the power/communication module 420 and provide charging power to the battery 430. The battery may be any appropriate rechargeable battery (or set of batteries) such as a five volt lithium ion battery. Alternatively, some embodiments may include receptacles for a set of disposable batteries.

The set of UI elements 435 may include various buttons, knobs, indicators, lights, etc. that may allow a user to control operation of the device 405 (and/or to control operation of a paired user device 415). Such UI elements 435 may include, for instance, control buttons located on the exterior of the device enclosure (e.g., volume up, volume down, scroll back, scroll forward, pause, phone answer, mute, etc.), a slide power button located on the top of the enclosure, one or more LED lights that may display multiple colors (e.g., blue to indicate pairing, red to indicate power, flashing to indicate charging, etc.).

The control module 440 may be adapted to monitor and/or control the operations of various other device modules. For instance, the control module may monitor the charge level of the battery 430 and control the amount of power delivered from the charger 425 to the battery 430 based at least partly on the monitored charge level. As another example, the control module 440 may receive volume control commands via the UI elements 435 and adjust the output of the amplifier 460 such that the output volume is adjusted appropriated based on the received volume commands. In some embodiments, the control module 440 may access local data (not shown) that may be available to the device 405. Such local data may include, for instance, operating parameters, audio message data, software instructions and/or data, etc.

The communication module 445 may be adapted to allow the hands free device 405 to be communicatively coupled to the user device 415 (e.g., via a wireless connection such as Bluetooth, WiFi, etc. and/or via a wired connection such as a USB connection).

The microphone 450 may be any set of devices adapted to capture audio. The microphone may typically be used to conduct phone calls with a paired device, capture voice commands, and/or otherwise allow a user to manipulate the hands free device 405 via aural interaction. Some embodiments may include an input port that is adapted to allow an external microphone or headset (not shown) to be connected.

The audio processing module 455 may receive audio data from the control module 440, communication module 445, and/or microphone 450 and may generate audio output that is able to drive the amplifier 460 (e.g., an amplifier adapted to provide an operating range of approximately five to ten meters with a signal to noise ration of eighty decibels and a sensitivity of about eighty decibels). The amplifier may, in turn, generate a set of outputs that are able to drive the speakers 465 (e.g., three watt speakers). Such speakers may be adapted to be at least partially dust and/or water proof. In some embodiments, the amplifier 460 may include an output port that is adapted to allow an external user device 470 (e.g., an external speaker or headset) to be connected.

The various internal components of the hands free device 405 may be connected, arranged, secured, etc. in various appropriate ways. For instance, some embodiments may include one or more printed circuit boards (PCBs) that is specifically adapted to secure and connect various components, and, in turn, to be secured to appropriate internal features of a device enclosure (e.g., prongs, clips, slots, etc.).

The hands free device of some embodiments may be used during a variety of riding activities associated with a variety of animals (e.g., horses, camels, etc.). In addition, the device may be used during activities associated with pack animals including donkeys, mules and burros even when no equestrian is on and/or near a particular animal. The device may be attached to a rider and/or animal using various different other features (e.g., a keychain clip) during any animal related activity.

One of ordinary skill in the art will recognize that system 400, and device 405, are conceptual in nature and may be implemented in various different ways without departing from the spirit of the invention. For instance, different embodiments may include various different components, different numbers of individual components, etc. In addition, the components may be arranged in various different ways.

### III. Methods of Operation

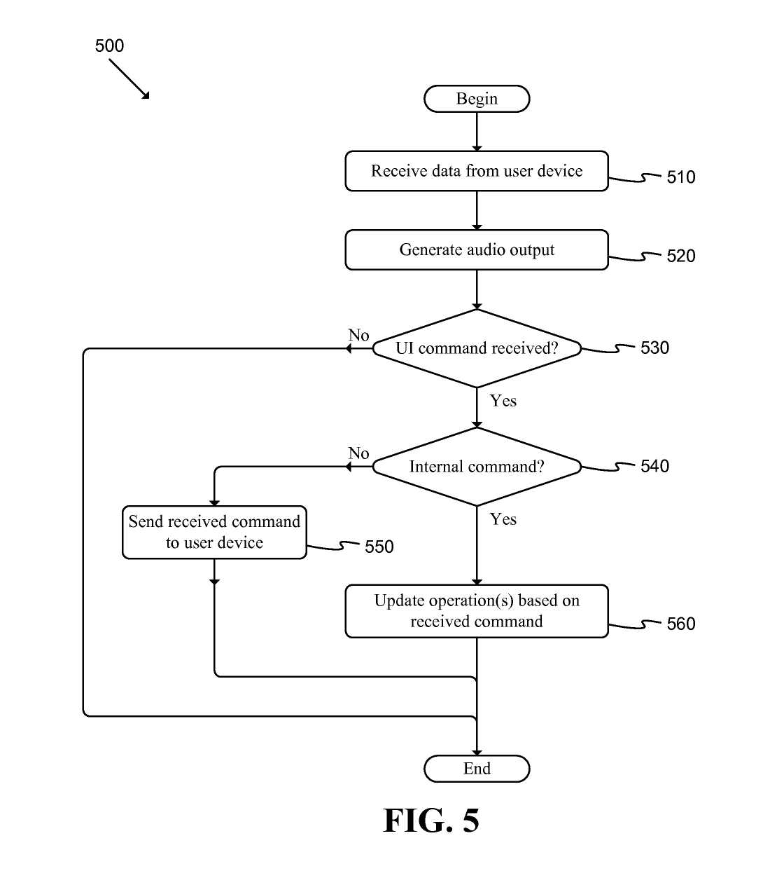

FIG. 5 illustrates a flow chart of a conceptual process 500 used by some embodiments to control mobile device operation. Such a process may begin, for instance, when a hands free device of some embodiments is communicatively coupled to a mobile device via an appropriate communication channel (e.g., using a Bluetooth connection).

As shown, the process may receive (at 510) data from the paired user device. Such data may be received via the communication module 445. The process may then generate (at 520) an audio output. Such an output may be generated using components such as audio processing module 455, amplifier 460, and speakers 465.

Process 500 may then determine (at 530) whether a UI command has been received. Such a determination may be made in various appropriate ways (e.g., the process may determine whether any UI elements 435 have been activated). If the process determines (at 530) that no UI command has been received, the process may end.

If the process determines (at 530) that a UI command has been received, the process may then determine (at 540) whether the received command is an internal command (i.e., a command that is intended to be executed by the hands free device rather than a paired user device). Such a determination may be made in various appropriate ways (e.g., the command may be compared to a table of internal commands).

If process 500 determines (at 540) that the command is not an internal command, the process may send (at 550) the command to the paired user device (e.g., via a Bluetooth channel) and then may end. Such commands may include, for instance, a next track command, an answer call command, etc.

Alternatively, if the process determines (at 540) that command is an internal command, the process may update (at 560) operation of the hands free device based at least partly on the received command and then may end. Such updates to operation may include, for instance, raising the output volume of the device, muting the device, etc.

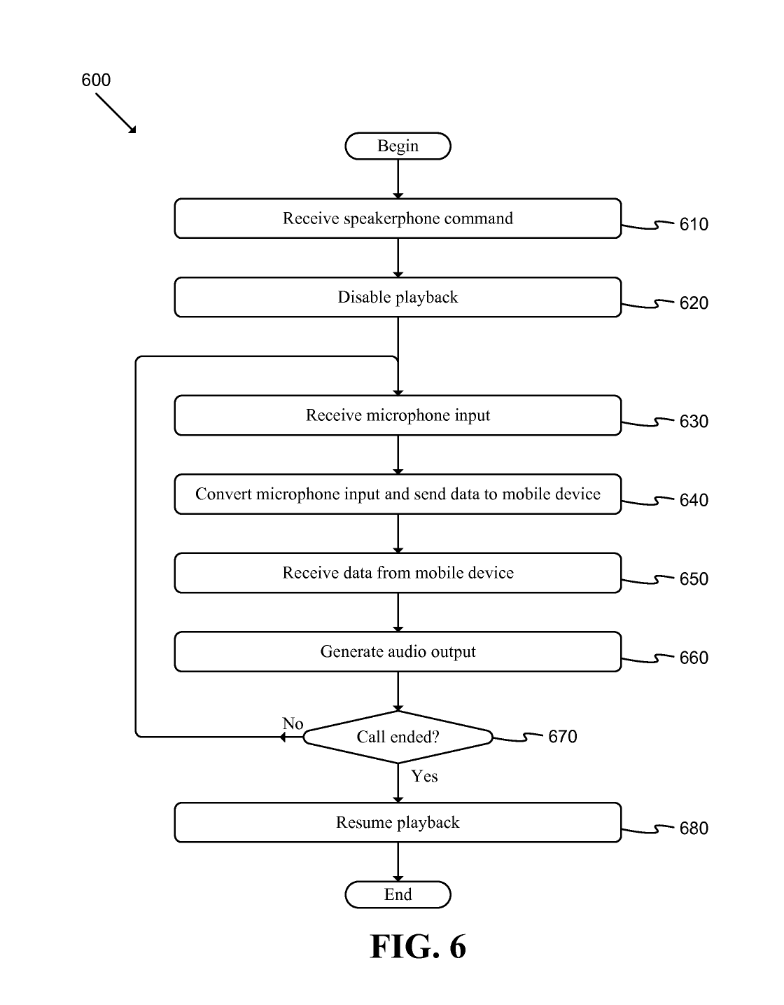

FIG. 6 illustrates a flow chart of a conceptual process 600 used by some embodiments to allow hands free operation of a mobile device during communication. Such a process may begin, for instance, when a hands free device of some embodiments is communicatively coupled to a mobile device via an appropriate communication channel (e.g., using a Bluetooth connection).

The process may receive (at 610) a speakerphone command. Such a command may be received in various appropriate ways (e.g., via a speakerphone button included in the set of UI elements 435). Next, the process may disable (at 620) playback (if playback of audio had previously been commenced). The process may then receive (at 630) microphone inputs. Such inputs may be received via a microphone such as microphone 450 described above.

Next, the process may convert (at 640) the audio input received at the microphone into an appropriate format and send the data to a paired mobile device. The audio input may be converted by a module such as the audio processing module 455 described above and sent to the paired mobile device via a module such as communication module 445 described above.

The process may then receive (at 650) data from the paired mobile device (e.g., via communication module 445) and generate (at 660) an audio output (e.g., using the audio processing module 455, the amplifier 460, and the speakers 465).

Next, the process may determine (at 670) whether the call has ended. Such a determination may be made in various appropriate ways (e.g., based on a selection of a UI element associated with the hands free device of some embodiments, based on a message or command received from a paired mobile device, etc.).

If the process determines (at 670) that the call has not ended, the process may repeat operations 630-670 until the process determines (at 670) that the call has ended. If the process determines that the call has ended, the process may resume (at 680) playback (if playback was previously disabled at 620) and then may end.

One of ordinary skill in the art will recognize that processes 500 and 600 may be implemented in various different ways without departing from the spirit of the invention. For instance, different embodiments may perform the operations in various different orders. In addition, some embodiments may include additional operations and/or eliminate various operations. In some embodiments, each process may be performed as part of a larger macro process or divided into a set of sub-processes. Each process may be performed continuously, at regular intervals, and/or based on certain criteria.

During use, the strap of some embodiments may be inserted into the plastic speaker enclosure and secured onto the saddle during or prior to riding or equestrian activity via dally technique to any part of the saddle. The device may also be attached to the saddle by any other method including snapping or clipping. After or before attachment to the saddle the device may be powered on and paired to a user device such as a smartphone, mp3 player, tablet device, etc. which allows wireless communication. After pairing the electronic device and/or any applicable electronics device(s), the rider may utilize any of the buttons accessible from the top or side of the electronics enclosure in order to adjust various parameters associated with the performance of the user device and/or hands free device while riding or near animals. During battery recharging the device may be connected, via an appropriate connector, to any appropriate power source suitable for providing the voltage required by the battery charger.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, Digital Signal Processors (DSPs), Application-Specific ICs (ASICs), Field Programmable Gate Arrays (FPGAs), etc.) the instructions cause the computational element(s) to perform actions specified in the instructions. In some embodiments, such software processes may be implemented completely using sets of electronic components that are arranged in specific configurations to implement the various desired functionality.

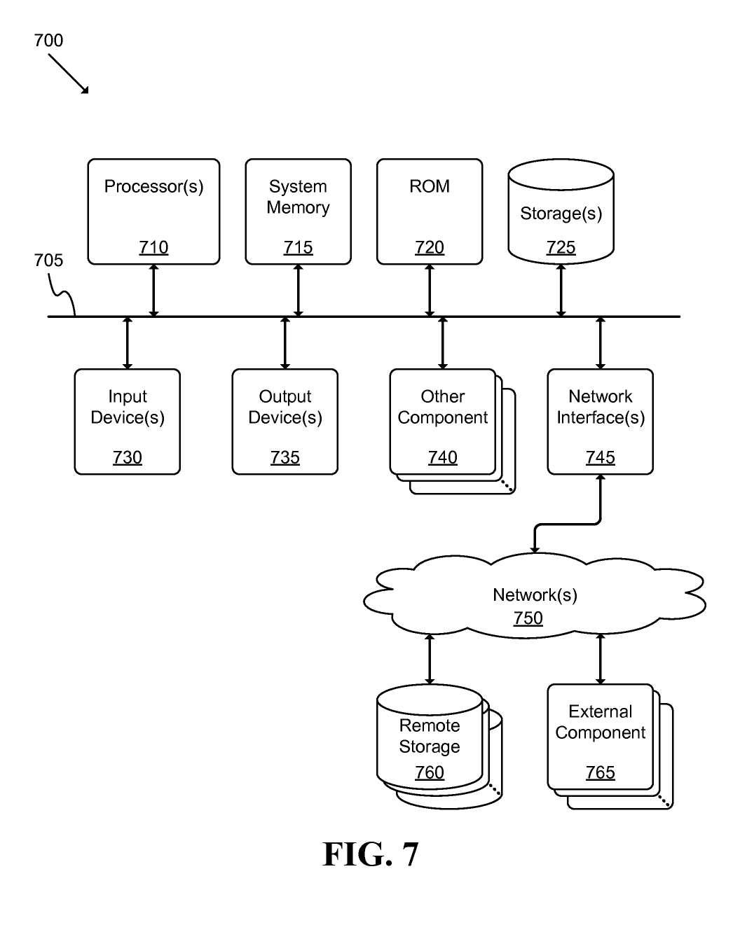

FIG. 7 conceptually illustrates a schematic block diagram of a computer system 700 with which some embodiments of the invention may be implemented. For example, the system described above in reference to FIG. 4 may be at least partially implemented using computer system 700. As another example, the processes described in reference to FIG. 5 and FIG. 6 may be at least partially implemented using sets of instructions that are executed using computer system 700.

Computer system 700 may be implemented using various appropriate devices. For instance, the computer system may be implemented using one or more personal computers (“PC”), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 700 may include at least one communication bus 705, one or more processors 710, a system memory 715, a read-only memory (ROM) 720, permanent storage devices 725, input devices 730, output devices 735, various other components 740 (e.g., a graphics processing unit), and one or more network interfaces 745.

Bus 705 represents all communication pathways among the elements of computer system 700. Such pathways may include wired, wireless, optical, and/or other appropriate communication pathways. For example, input devices 730 and/or output devices 735 may be coupled to the system 700 using a wireless connection protocol or system.

The processor 710 may, in order to execute the processes of some embodiments, retrieve instructions to execute and/or data to process from components such as system memory 715, ROM 720, and permanent storage device 725. Such instructions and data may be passed over bus 705.

System memory 715 may be a volatile read-and-write memory, such as a random access memory (RAM). The system memory may store some of the instructions and data that the processor uses at runtime. The sets of instructions and/or data used to implement some embodiments may be stored in the system memory 715, the permanent storage device 725, and/or the read-only memory 720. ROM 720 may store static data and instructions that may be used by processor 710 and/or other elements of the computer system.

Permanent storage device 725 may be a read-and-write memory device. The permanent storage device may be a non-volatile memory unit that stores instructions and data even when computer system 700 is off or unpowered. Computer system 700 may use a removable storage device and/or a remote storage device 760 as the permanent storage device.

Input devices 730 may enable a user to communicate information to the computer system and/or manipulate various operations of the system. The input devices may include keyboards, cursor control devices, audio input devices and/or video input devices. Output devices 735 may include printers, displays, and/or audio devices. Some or all of the input and/or output devices may be wirelessly or optically connected to the computer system.

Other components 740 may perform various other functions. These functions may include performing specific functions (e.g., graphics processing, sound processing, etc.), providing storage, interfacing with external systems or components, etc.

Finally, as shown in FIG. 7, computer system 700 may be coupled to one or more networks 750 through one or more network interfaces 745. For example, computer system 700 may be coupled to a web server on the Internet such that a web browser executing on computer system 700 may interact with the web server as a user interacts with an interface that operates in the web browser. Computer system 700 may be able to access one or more remote storages 760 and one or more external components 765 through the network interface 745 and network 750. The network interface(s) 745 may include one or more application programming interfaces (APIs) that may allow the computer system 700 to access remote systems and/or storages and also may allow remote systems and/or storages to access computer system 700 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 700 may be used in conjunction with the invention. Moreover, one of ordinary skill in the art will appreciate that many other system configurations may also be used in conjunction with the invention or components of the invention.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

It should be understood, of course, that the foregoing relates to illustrative details of exemplary embodiments of the invention and that modifications may be made without departing from the spirit and scope of the invention as defined by the following claims.

I claim:

1. A hands free device adapted to be used during equestrian riding activity, the hands free device comprising:
an enclosure that houses a set of speakers, a microphone, and a wireless communication module; and
a securing feature that is adapted to be coupled to the enclosure and secured to an attachment point.

2. The hands free device of claim 1, wherein the wireless communication module is adapted to allow the hands free device to be communicatively coupled to a mobile device via a Bluetooth connection.

3. The hands free device of claim 1, wherein the securing feature is a silicon strap.

4. The hands free device of claim 3, wherein a first portion of the securing feature is adapted to be secured about the enclosure using a compression fit and a second portion of the securing feature is adapted to be selectively coupled to a retaining element of the securing feature in order to secure the second portion of the securing feature to the attachment point.

5. The hands free device of claim 1, wherein the attachment point comprises a section of a saddle.

6. The hands free device of claim 5, wherein the attachment point comprises a horn.

7. The hands free device of claim 1, wherein the enclosure comprises a set of user interface elements including at least one button.

8. A portable speaker adapted to be used during horseback riding, the portable speaker comprising:
a crescent-shaped enclosure comprising:
a set of speakers; and
a recessed area running along an outer surface of the enclosure; and
a securing strap comprising:
a retaining loop adapted to form a compression fit about the enclosure at the recessed area; and
an adjustable securing feature that includes a retaining element and a set of receptacles, each receptacle adapted to be able to be coupled to the retaining element.

9. The portable speaker of claim 8, wherein the crescent-shaped enclosure comprises a set of user interface (UI) elements, a plastic structure, rubberized paint, and a set of recessed cavities, each cavity associated with a removable silicon cover.

10. The portable speaker of claim 9, wherein a first cavity in the set of cavities houses a universal serial bus (USB) port and a second cavity in the set of cavities houses an earphone jack.

11. The portable speaker of claim 9, wherein the UI elements comprise a first button associated with a volume up command and a next track command, a second button associated with a play/pause command and a phone answer command, a third button associated with a volume down command and a previous track command.

12. The portable speaker of claim 8, wherein the securing strap comprises silicon.

13. The portable speaker of claim 12, wherein the retaining element is a nail head and each receptacle in the set of receptacles is an elliptical opening through the strap.

14. The portable speaker of claim 8, further comprising a wireless communication module that is adapted to allow the portable speaker to communicate with a mobile device.

15. A media playback device adapted for use during horseback riding, the device comprising:
a microphone adapted to receive audio data and send the received audio data to a paired mobile device;
a wireless communication module that is adapted to allow the media playback device to receive audio content from the paired mobile device;
an amplifier adapted to convert the received audio content into a set of outputs capable of driving a set of speakers;
a rechargeable battery and associated charging module; and
a removable strap adapted to secure the media playback device to an attachment point.

16. The media playback device of claim 15, wherein the paired mobile device is a smartphone.

17. The media playback device of claim 16, wherein the media playback device is able to provide audio input and output associated with a phone call performed in conjunction with the paired mobile device.

18. The media playback device of claim 17, wherein the mobile device is communicatively coupled to the media playback device via a Bluetooth connection.

19. The media playback device of claim 15 further comprising a set of user interface (UI) elements, the UI elements including a light emitting diode (LED) indicator light and three multi-function buttons.

20. The media playback device of claim 19, wherein the LED indicator light is able to generate a plurality of output colors, each color in the plurality of colors associated with a status of the media playback device.
